(19) United States
(12) Patent Application Publication
(10) Pub. No.: US 2005/0135479 A1
(43) Pub. Date: Jun. 23, 2005

(54) Method and apparatus for processing digital motion picture

(75) Inventor: Shihwa Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/001,643

(22) Filed: Dec. 2, 2004

(30) Foreign Application Priority Data
Dec. 2, 2003 (KR) 2003-86741

(51) Int. Cl. H04N 7/12

(52) U.S. Cl. 375/240.12; 375/240.24; 375/240.18; 375/240.03

(57) ABSTRACT

A method for processing a digital motion picture, which includes, when the digital motion picture is coded, dividing a motion compensation error image, which is the result of removing temporal redundancy of the digital motion picture, into horizontal or vertical blocks, predicting a motion compensation error of a current block using a previous block neighboring the current block by a predetermined pixel distance, and performing an orthogonal transform on a predicted error image having the predicted motion compensation errors; and when the coded digital motion picture is decoded, recovering the predicted error image by performing an inverse orthogonal transform and recovering the motion compensation error image from the recovered predicted error image wherein, the current block is a block to be currently processed, and the previous block is a block previously processed.

### CROSS-REFERENCE TO RELATED APPLICATION

This application claims the benefit of Korean Patent Application No. 2003-86741, filed on Dec. 2, 2003, in the Korean Intellectual Property Office, the disclosure of which is incorporated herein by reference.

### BACKGROUND OF THE INVENTION

1. Field of the Invention

The present invention relates to processing of an image, and more particularly, to a digital motion picture processing method and apparatus for coding and decoding a digital motion picture.

2. Description of the Related Art

FIG. 1 is a view explaining an example of a motion compensation (MC) error.

In general, an MC error in an MC error image, which results from removing temporal redundancy in a digital motion picture, is greatly distributed around the edge of an object that is moving within the MC error image. The great distribution of the MC error results because motion estimation and motion compensation are performed for each macroblock (MB), and respective MBs include one motion vector during coding of a motion picture. In other words, a relatively large MC error may occur due to a motion component, among the motion components included in an MB, that is not reflected in one motion vector.

Errors at portions of an image other than the surroundings of the edges thereof have values close to “0”, while errors on the surroundings of the edges of the image are relatively large. Thus, performing a Discrete Cosine Transform (DCT) on the surroundings of error values on the edges may disperse data rather than concentrate data. In other words, performing a DCT on the MC error may bring about poorer results than performing a DCT on a source image.

Accordingly, a conventional method of coding and decoding a digital motion picture may deteriorate the effect of the DCT.

### SUMMARY OF THE INVENTION

Additional aspects and/or advantages of the invention will be set forth in part in the description which follows and, in part, will be obvious from the description, or may be learned by practice of the invention.

According to an aspect of the invention, there is provided a method of processing a digital motion picture, including: when the digital motion picture is coded, dividing a motion compensation error image, which is the result of removing temporal redundancy of the digital motion picture, into horizontal or vertical blocks, predicting a motion compensation error of a current block using a previous block neighboring by a unit pixel distance to the current block, and performing an orthogonal transform on a predicted error image having the predicted motion compensation errors; and when the coded digital motion picture is decoded, recovering the predicted error image by performing an inverse orthogonal transform and recovering the motion compensation error image from the recovered predicted error image. Here, the current block is a block to be currently processed, and the previous block is a block previously processed.

According to another aspect of the invention, there is provided an apparatus for processing a digital motion picture, including: a coder which divides a motion compensation error image, which is a result of removing temporal redundancy of the digital motion picture, into horizontal or vertical blocks, predicts a motion compensation error of a current block using a previous block neighboring by a unit pixel distance to the current block, and performs an orthogonal transform on a predicted error image having the predicted motion compensation errors; and a decoder which recovers the predicted error image by performing an inverse orthogonal transform and recovers the motion compensation error image from the recovered predicted error image.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view for explaining an example of an MC error;

FIG. 2 is a flowchart of a method of processing a digital motion picture, according to a preferred embodiment of the invention;

FIGS. 3A through 3C are graphs for explaining the correlations between neighboring pixels;

FIG. 4 is a flowchart of operation 10 of the method of FIG. 2, according to an embodiment of the invention;

FIG. 5 is a flowchart of operation 12 of the method of FIG. 2, according to an embodiment of the invention;

FIG. 6 is a flowchart of operation 10 of the method of FIG. 2, or operation 32 of FIG. 4, according to an embodiment of the invention;

FIG. 7 is a diagram of an example of an MC error image;

FIG. 8 is a flowchart of operation 70 of FIG. 6 according to an embodiment of the invention;

FIG. 9 shows an example of an MB to aid in understanding a process of calculating first and second sums of FIG. 8;

FIG. 10 is a flowchart of operation 72 of FIG. 6, according to an embodiment of the invention;

FIGS. 11A through 11E show examples of horizontal blocks to aid in understanding operation 72 of FIG. 6;

FIGS. 12A through 12F illustrate operations 72 of calculating a reference value in FIG. 10 according to embodiments of the invention;

FIG. 13 is a flowchart of operation 12 of FIG. 2 or operation 56 of FIG. 5 according to an embodiment of the invention;

FIG. 14 is a block diagram of an apparatus for processing a digital motion picture according to an embodiment of the invention;

FIG. 15 is a block diagram of a coder of the apparatus of FIG. 14 according to an embodiment of the invention;

FIG. 16 is a block diagram of a decoder of the apparatus of FIG. 14 according to an embodiment of the invention;

FIG. 17 is a block diagram of a coder of the apparatus of FIG. 14, or a predicted error image generator of FIG. 15 according to an embodiment of the invention;

FIG. 18 is a block diagram of a block determiner of FIG. 17 according to an embodiment of the invention;

FIG. 19 is a block diagram of an error predictor of FIG. 17 according to an embodiment of the invention; and

FIG. 20 is a block diagram of a decoder of FIG. 14, or a first MC error image recovery unit of FIG. 16 according to an embodiment of the invention.

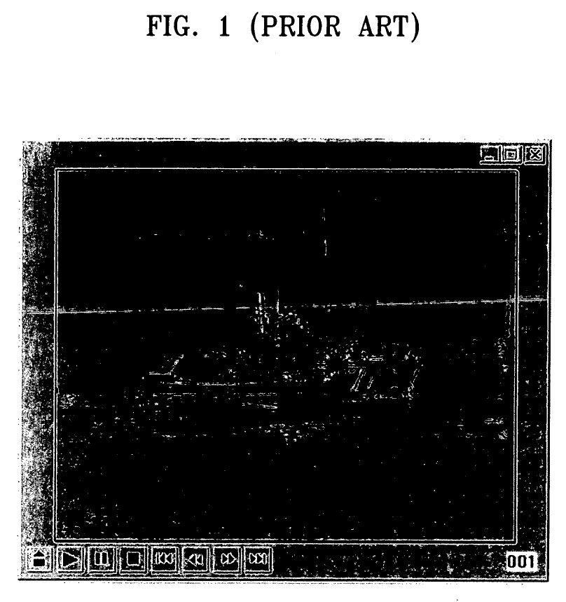

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

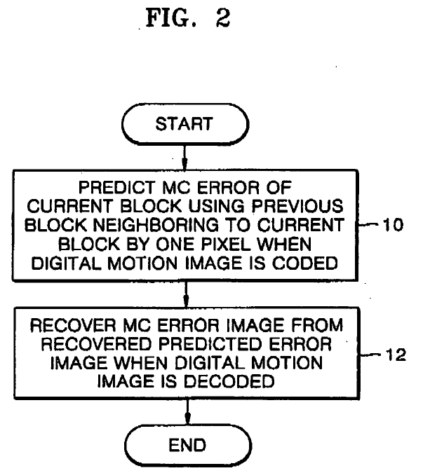

Hereinafter, a method of processing a digital motion picture, according to an aspect of the invention, will be described with reference to FIG. 2. FIG. 2 is a flowchart of a method of processing a digital motion picture. The method includes operation 10 of coding a digital motion picture and operation 12 of decoding the coded digital motion picture.

Referring to FIG. 2, in operation 10, a digital motion picture is coded. In other words, an MC error image, which is the result of removing temporal redundancy between digital motion pictures neighboring in time, is divided into blocks. Here, the blocks may be horizontal or vertical blocks, which will be described later. An MC error of a block to be currently processed (hereinafter referred to as a current block) is predicted using a neighboring block at a distance of one that was previously processed (hereinafter referred to as a previous block). An orthogonal transform (OT) is performed on a predicted error image having the predicted MC errors. Here, the result of removing the temporal redundancy from the digital motion picture is obtained using a motion vector that is generated from the digital motion picture. This is disclosed in standards such as MPEG-1, -2, and -4, Video, H.261, H.263, and H.264.

When operation 10 is performed in the unit of MB of the MC error image, each MB is segmented into horizontal or vertical blocks. Here, an MC error of each of horizontal or vertical blocks to be currently processed is predicted using a horizontal or vertical block that was previously processed and that neighbors the horizontal or vertical block by a predetermined pixel distance, such as one pixel. In other words, all MC errors are predicted for the respective horizontal or vertical blocks of each of the MBs included in the MC error image to determine a predicted error image having the predicted MC errors for the MC error image.

In operation 12, when the coded digital motion picture is decoded, the predicted error image is recovered by performing an inverse orthogonal transform (IOT), and the MC error image is recovered from the recovered predicted error image.

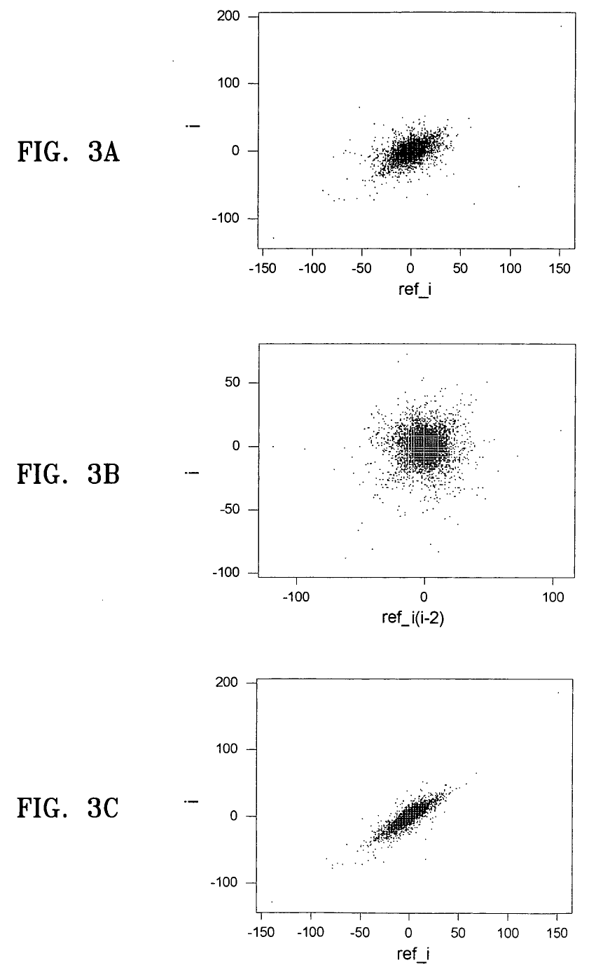

A method of processing of the digital motion picture according to an aspect of the invention will be explained with reference to FIGS. 3A through 3C. FIGS. 3A through 3C are graphs for explaining correlations between neighboring pixels.

FIG. 3A shows a correlation between neighboring pixels at a unit pixel distance from a reference pixel in all directions. FIG. 3B shows correlation between neighboring pixels at twice a unit pixel distance from a reference pixel in all directions. FIG. 3C shows correlation between pixels closest to a reference pixel in all directions. It is understood that the pixel distance may be any distance and is not limited to one unit pixel or two unit pixels.

In each of FIGS. 3A and 3C, luminance level error values ref_i of neighboring pixels at a unit pixel distance from a reference pixel are plotted along the horizontal axis, and a luminance level error value i of the neighboring pixel is plotted along the vertical axis. In FIG. 3B, luminance level error values ref_i(i-2) of neighboring pixels at twice a unit pixel distance from a reference pixel are plotted along the horizontal axis, and a luminance level error value i of the neighboring pixel is plotted along the vertical axis.

A correlation coefficient of the data graphed in FIG. 3A is 0.510, which is a relatively large correlation coefficient value. The large value of the correlation coefficient indicates that the correlation between neighboring pixels at a unit pixel distance is great. However, the correlation coefficient of the data graphed in FIG. 3B is 0.032, indicating that the correlation between neighboring pixels at twice a unit pixel distance is lower than the correlation coefficient between neighboring pixels at a unit pixel distance. The correlation coefficient of the data graphed in FIG. 3C is very high: 0.861, indicating that the correlation between pixels similar to the reference pixel among neighboring pixels at a unit pixel distance from the reference pixel are very high.

Thus, in operation 10 of FIG. 2, an MC error of a current block is predicted using a previous block neighboring by a unit pixel distance to the current block when the digital motion picture is coded.

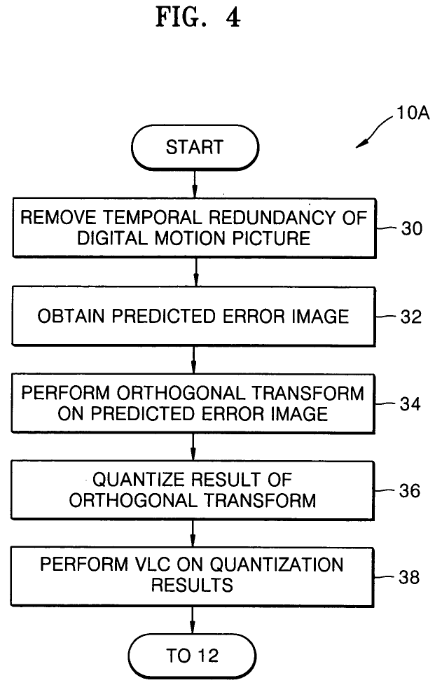

A method of processing a digital motion picture according to an aspect of the invention is described below. FIG. 4 is a flowchart of an aspect 10A of operation 10 of the method of FIG. 2. Operation 10A includes operation 30 of removing temporal redundancy of a digital motion picture, operations 32, 34, and 36 of removing spatial redundancy of the digital motion picture, and operation 38 of performing variable length coding (VLC).

Referring to FIG. 4, in operation 30, temporal redundancy of a digital motion picture is removed and the resulting image is determined as an MC error image.

In operation 32, the MC error image is divided into horizontal or vertical blocks and an MC error of a current horizontal or vertical block is predicted using a previous horizontal or vertical block neighboring by a unit pixel distance to the current horizontal block, to obtain a predicted error image having the predicted MC errors.

In operation 34, an OT is performed on the predicted error image. Here, the OT may be a DCT, or the like, and may contribute to concentrating energy and diminishing correlation between pixels.

In operation 36, the result of the OT is quantized. For example, the result of the OT may be compressed by performing quantization corresponding to information concerning a quantization magnitude or the like that may be input from an external source. In other words, operations 32, 34, and 36 are performed to remove a spatial redundancy from the result of removing temporal redundancy of a digital motion picture.

In operation 38, VLC is performed on the quantization results so as to be suitable for a predetermined bit rate. For example, operation 38 may be performed to remove statistical redundancy from the result of removing spatial redundancy.

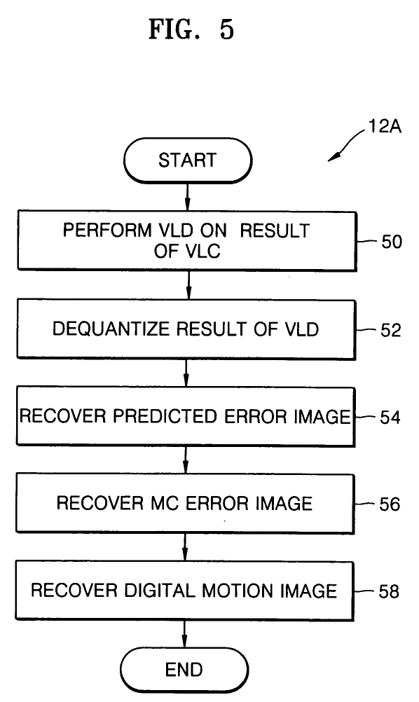

FIG. 5 is a flowchart of an aspect 12A of operation 12 of the method of FIG. 2, according to the invention. Operation 12A includes operations 50 and 52 of performing variable length decoding (VLD) and inverse quantization, and operations 54, 56, and 58 of recovering a predicted error image, an MC error image, and a digital motion picture. Referring to FIG. 5, in operation 50, VLD is performed on the result of VLC.

Either operation 10 of the method of FIG. 2, or operation 10A shown in FIG. 4, may be performed by a coder (not shown). Either operation 12 of the method of FIG. 2, or operation 12A shown in FIG. 5, may be performed by a decoder (not shown). For example, the result of final coding by the coder, i.e., the result of VLC, may be transmitted to the decoder or stored in an additional storage (not shown). As such, the decoder reads and decodes the result of VLC that is transmitted from the coder or stored in the additional storage.

In operation 52, the VLD result is inverse-quantized. In operation 54, IOT is performed on the inverse quantization results to recover a predicted error image. In operation 56, an MC error image is recovered from the recovered predicted error image. In operation 58, a digital motion picture is recovered using the recovered MC error image.

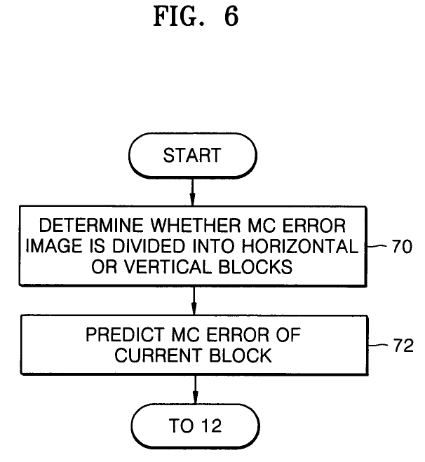

Operation 10 of coding the digital motion picture in the method of FIG. 2 is explained in more detail below. FIG. 6 is a flowchart of an aspect of operation 10 of the method of FIG. 2, or operation 32 shown in FIG. 4, according to the invention, including operation 70 of determining a direction along which an MC error image is to be analyzed and operation 72 of predicting MC errors. In operation 70, a determination is made as to whether each of MBs of which an MC error image is included is divided into horizontal or vertical blocks.

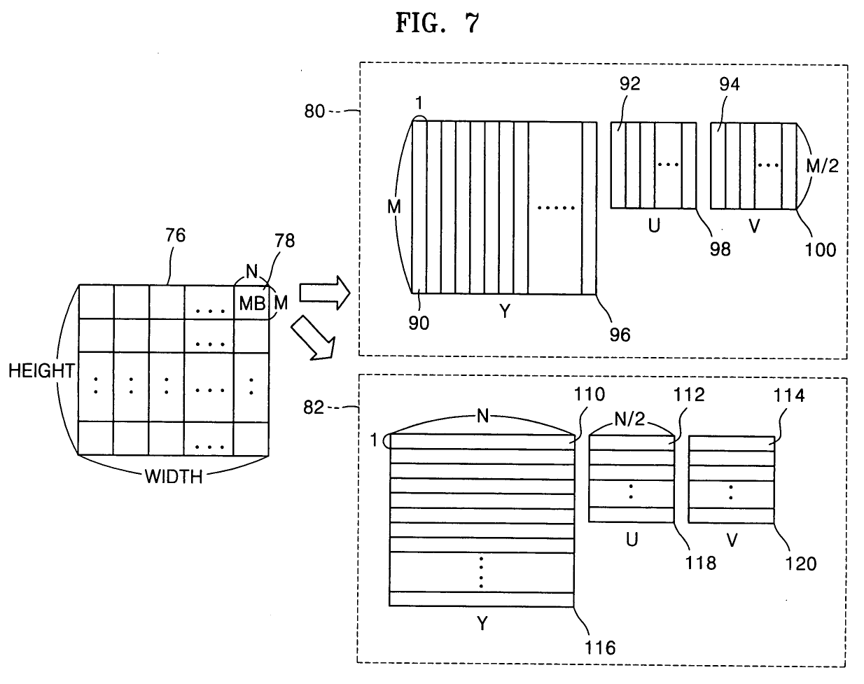

FIG. 7 is a an illustration of an MC error image 76, which includes MBs 78, an MB 80 being segmented into vertical blocks, and an MB 82 being segmented into horizontal blocks. Referring to FIG. 7, the MC error image 76 includes a plurality of MBs 78 and has a predetermined width and height. Here, each of the MBs 78 has an N×M (width×length) size, where N and M may or may not be the same. According to most conventional standards, N and M each have a size of “16” bits. As shown in FIG. 7, each of the MBs 78 may be determined to be divided into vertical or horizontal blocks.

As shown in FIG. 7, the MB 80 includes vertical blocks 96 with respect to a luminance component Y, and/or vertical blocks 98 with respect to a color component U, and/or vertical blocks 100 with respect to a color component V. For example, the length M/2 of each of the vertical blocks 98 or 100 with respect to the color component U or V may be half the length M of each of the vertical blocks 96 with respect to the luminance component Y. It is understood that the length is not limited to any particular length.

Similarly, the MB 82 includes horizontal blocks 116 with respect to a luminance component Y, and/or horizontal blocks 118 with respect to a color component U, and/or horizontal blocks 120 with respect to a color component V. For example, the width N/2 of each of the horizontal blocks 118 or 120 with respect to the color component U or V may be half the width N of each of the horizontal blocks 116 with respect to the luminance component Y. It is understood that the width is not limited to any particular length.

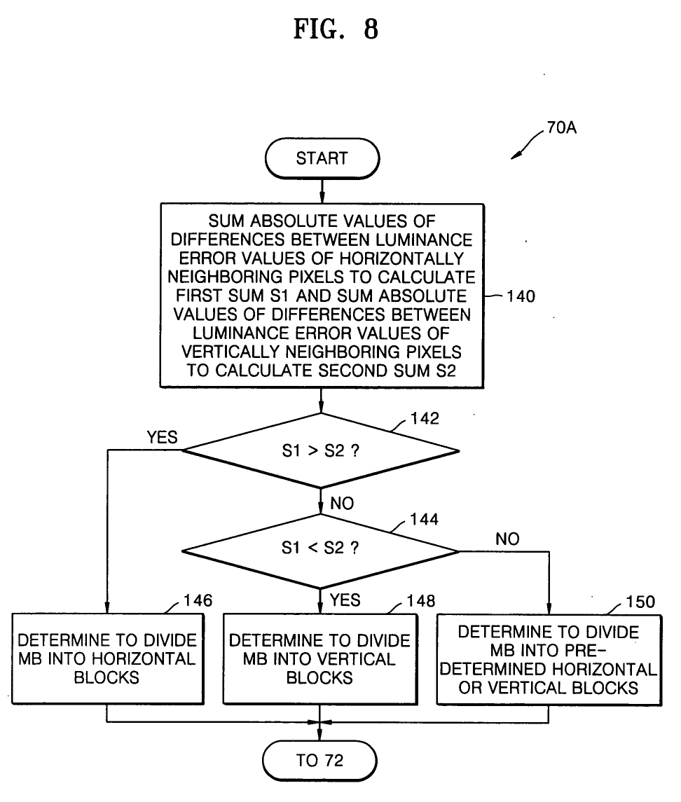

FIG. 8 is a flowchart of an aspect 70A of operation 70 of FIG. 6, according to the invention, including operation 140 of calculating first and second sums S1 and S2 and operations 142, 144, 146, 148, and 150 of determining a direction along which an MB is to be analyzed according to sizes of the first and second sums S1 and S2.

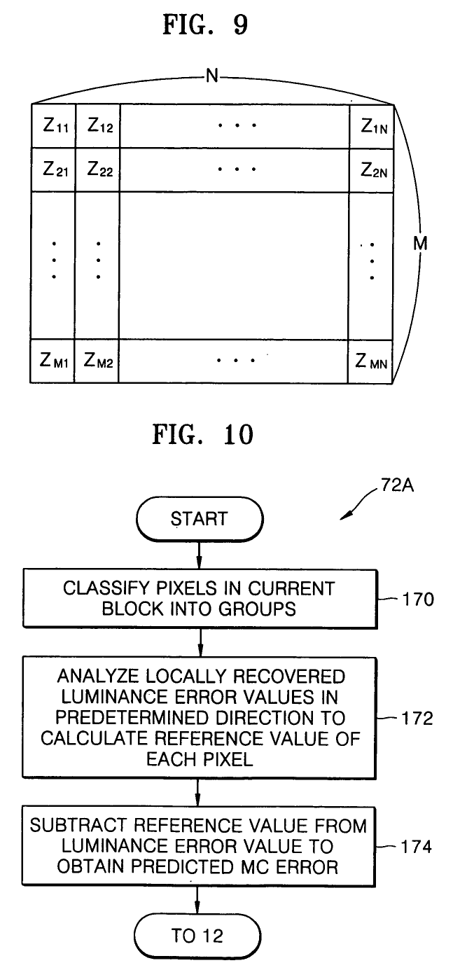

FIG. 9 is a diagram of an example of an arbitrary MB 78 to illustrate a process of calculating the first and second sums S1 and S2 of FIG. 8. The MB 78 includes N×M luminance error values Z₁₁, Z₁₂, . . . , Z_{1N}, Z₂₁, Z₂₂, . . . , Z_{2N}, . . . , Z_{M1}, Z_{M2}, . . . , and Z_{MN}.

To perform operation 70 of FIG. 6, in operation 140, absolute values of differences between luminance error values of horizontally neighboring pixels of FIG. 9 in the MB 78 are summed, as shown in Equation 1, to obtain the first sum S1, and absolute values of differences between luminance error values of vertically neighboring pixels of FIG. 9 are summed as shown in Equation 2 to obtain the second sum S2.

$$\begin{matrix}S 1 = {\sum }_{i = 1}^{M} {\sum }_{j = 1}^{N - 1} \vert {Z}_{ij} - {Z}_{i ( j + 1 )} \vert & ( 1 ) \\ S 2 = {\sum }_{l = 1}^{N} {\sum }_{k = 1}^{M - 1} \vert {Z}_{kl} - {Z}_{( k + 1 ) l} \vert & ( 2 )\end{matrix}$$

After operation 140, in operation 142, a determination is made as to whether the first sum S1 is greater than the second sum S2. When the first sum S1 is greater than the second sum S2, the MB 78 is divided into horizontal blocks 82 in operation 146, as shown in FIG. 7.

When the first sum S1 is not greater than the second sum S2, a determination is made in operation 144 as to whether the first sum S1 is less than the second sum S2. When the first sum S1 is less than the second sum S2, the MB 78 is divided into vertical blocks 80 in operation 148, as shown in FIG. 7. When the first sum S1 is equal to the second sum S2, the MB 78 is divided into predetermined horizontal or vertical blocks in operation 150. The predetermined horizontal or vertical blocks are the result of determining in advance whether to divide the MB 78 into horizontal blocks or into vertical blocks when the first sum S1 is equal to the second sum S2.

In operation 72, an MC error of a current block is predicted using a previous block neighboring the current block by a unit pixel distance to obtain a predicted error image having the predicted MC errors.

FIG. 10 is a flowchart of an aspect 72A of operation 72 of FIG. 6, according to the invention, including operations 170, 172, and 174 of predicting MC errors using luminance error values and reference values.

According to an aspect of the invention, operation 72 of FIG. 6 may include only operations 172 and 174 of FIG. 10. In this case, in operation 172, a reference value of each of pixels included in a current horizontal or vertical block is calculated using locally recovered luminance error values of pixels included in a previous horizontal or vertical block. The coder generally includes a local decoding unit (not shown) that performs the same operation as the decoder. Here, the local decoding unit recovers the same luminance error values to be recovered by the decoder, which when recovered by the local decoding unit are referred to as locally recovered luminance error values.

In operation 174, the reference value is subtracted from a luminance error value of each of the pixels included in the current horizontal or vertical block and the subtraction result is determined as a predicted MC error of the corresponding pixel.

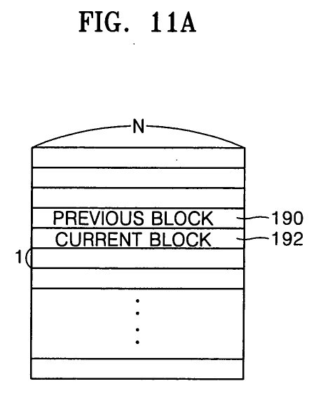

FIGS. 11A through 11E are illustrations of horizontal blocks of operation 72 of FIG. 6. FIG. 11A shows a horizontal block 116,118, or 120, which has been divided to analyze the MB 78 in a horizontal direction. Referring to FIG. 11A, reference numeral 190 denotes a previous block, and reference numeral 192 denotes a current block.

FIG. 11B illustrates pixels a0, a1, a2, a3, a4, a5, a6, a7, a8, a9, a10, a11, a12, a13, a14, and a15 in a current horizontal block 192A, which are classified into a group 210. FIG. 11C illustrates pixels a0, a1, a2, a3, a4, a5, a6, a7, b0, b1, b2, b3, b4, b5, b6, and b7 in a current horizontal block 192B which are classified into groups 212 and 214. FIG. 11D illustrates pixels a0, a1, a2, a3, b0, b1, b2, and b3, c0, c1, c2, c3, d0, d1, d2, and d3 in a current horizontal block 192C, which are classified into groups 216, 218, 220, and 222. FIG. 11E illustrates pixels a0, a1, b0, b1, c0, c1, d0, d1, e0, e1, f0 f1, g0, g9, h0, and h1 in a current horizontal block 192D, which are classified into groups 226, 228, 230, 232, 234, 236, 238, and 240.

According to another aspect of the invention, operation 72 of FIG. 6 may include operations 170, 172, and 174 of FIG. 10. As shown, in operation 170, pixels in a current block are classified into at least one group of a predetermined number of groups. The predetermined number of groups may be determined by a user. For example, pixels a0, a1, a2, a3, a4, a5, a6, a7, a8, a9, a10, a11, a12, a13, a14, and a15 in the current block 192 of a current block may be classified into one, two, four, or eight groups as shown in FIG. 11B, 11C, 11D, or 11E. It is understood that the block may be classified into any number of groups as determined by the user.

In operation 172, locally recovered luminance error values of pixels included in a previous block are analyzed in a predetermined direction, which is equally applied to each of groups of pixels, to obtain a reference value. The predetermined direction may be determined by the user.

For example, when a reference value of each of the pixels a0, a1, a2, a3, a4, a5, a6, a7, a8, a9, a10, a11, a12, a13, a14, and a15 in the group 210 of FIG. 11B is calculated, locally recovered luminance error values of pixels included in a reference block 190A of a previous horizontal block are analyzed in the same direction. Therefore, it is assumed that the locally recovered luminance error values of the pixels in the previous horizontal block 190A are analyzed in a straight-line direction when a reference value of the pixel a2 in the current horizontal block 192A is calculated. Even when calculating a reference value of the pixel a6 belonging to the same group as the pixel a2 included in the current horizontal block 192A, the locally recovered luminance error values of the pixels in the horizontal block 190A are analyzed in the straight-line direction. Similarly, when a reference value of each of pixels in the groups 212, 214, 216, 218, 220, 222, 226, 228, 230, 232, 234, 236, 238, and 240 of FIGS. 11C through 11E is calculated, locally recovered luminance error values of pixels included in a previous horizontal block 190B, 190C, or 190D are analyzed in the same direction.

A reference value of each of pixels in a first processed block 90, 92, 94, 110,112, or 114 in the MB 80 or 82 of FIG. 7 may be set to “0” because there is no previous block.

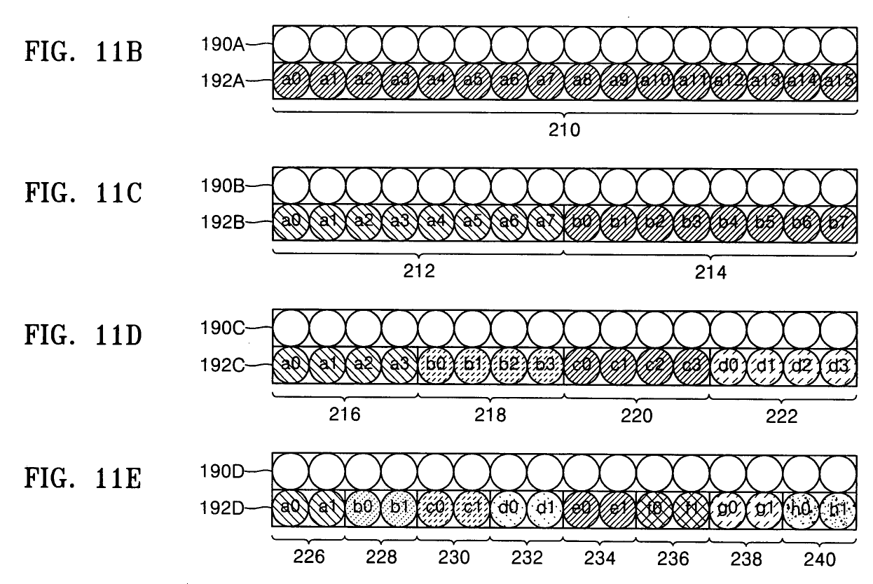

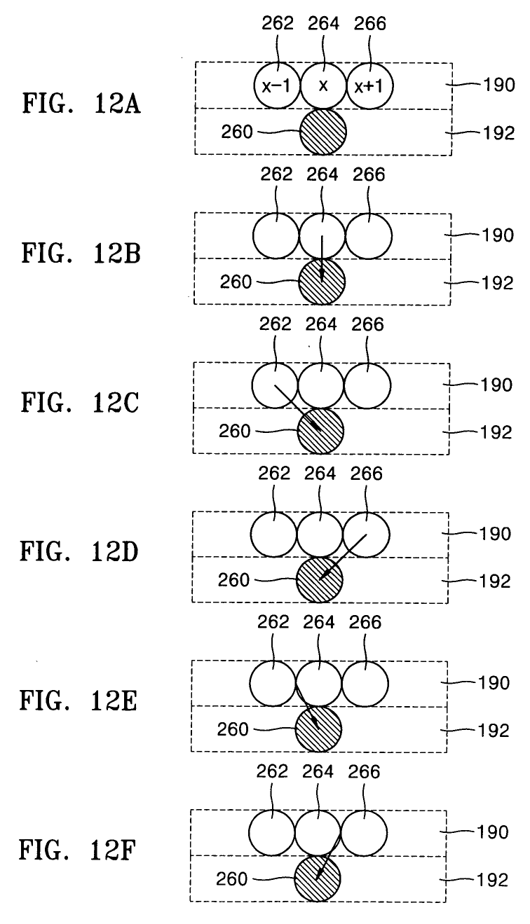

FIGS. 12A through 12F show aspects of operation 172 shown in FIG. 10 of calculating a reference value r(x). The horizontal direction in each of FIGS. 12A through 12F denotes a position.

A reference value r(x) of a pixel 260 at a random position x of a current block 192 may be calculated using Equation 3, 4, 5, 6, 7, or 8:
r(x)=0 (3)
wherein r(x)=0 indicates that the reference value r(x) of the pixel 260 at the random position x is calculated regardless of locally recovered luminance error values of pixels 262, 264, and 266 in a previous block 190 as shown in FIG. 12A.
   r(x)=p(x) (4)
wherein p(x) denotes a locally recovered luminance error value of the pixel 264 at position x of the previous block 190. Here, r(x)=p(x) indicates that the reference value r(x) of the pixel 260 is calculated using only a locally recovered luminance error value p(x) of the pixel 264 at position x of the previous block 190 as shown in FIG. 12B. In this case, a predetermined direction along which the previous block 190 is to be analyzed is a straight-line direction.
   r(x)=p(x−1) (5)
wherein r(x)=p(x−1) indicates that the reference value r(x) of the pixel 260 is calculated using only a locally recovered luminance error value p(x−1) of the pixel 262 at a position x−1 of the previous block 190 as shown in FIG. 12C. In this case, a predetermined direction along which the previous block 190 is to be analyzed is a leftward inclined direction.
   r(x)=p(x+1) (6)
wherein r(x)=p(x+1) indicates that the reference value r(x) of the pixel 260 is calculated using only a locally recovered luminance error value p(x+1) of the pixel 266 at a position x+1 of the reference block 190 as shown in FIG. 12D. In this case, a predetermined direction along which the previous block 190 is to be analyzed is a rightward inclined direction.

$$r ( x ) = \frac{p ( x - 1 ) + P ( x ) + 1}{2} \qquad ( 7 )$$
wherein r(x)=(p(x−1)+p(x)+1)/2 indicates that the reference value r(x) of the pixel 260 is calculated using a median value of locally recovered luminance error values p(x−1) and p(x) of the pixels 262 and 264 at positions x−1 and x of the previous block 190 as shown in FIG. 12E. In this case, a predetermined direction along which the previous block 190 is to be analyzed is a leftward inclined direction.

$$r ( x ) = \frac{p ( x ) + p ( x + 1 ) + 1}{2} \qquad ( 8 )$$
wherein r(x)=p(x)+p(x+1)+1)/2 indicates that the reference value r(x) of the pixel 260 is calculated using a median value of locally recovered luminance error values p(x) and p(x+1) of the pixels 264 and 266 at positions x and x+1 of the previous block 190 as shown in FIG. 12F. In this case, a predetermined direction along which the previous block 190 is to be analyzed is a rightward inclined direction.

As the current block 192 is minutely divided into groups of pixels, an MC error decreases while an overhead increases. Thus, a tradeoff between the overhead and the number of groups may be set.

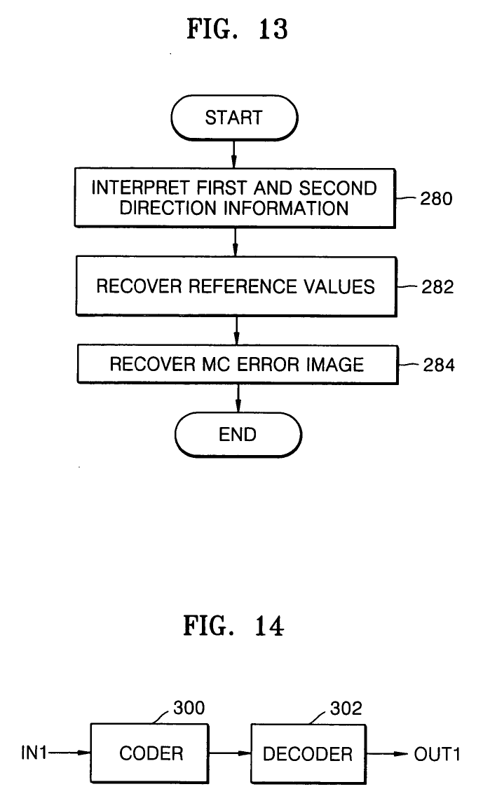

Operation 12 of decoding the digital motion picture in the method of FIG. 2 is described in more detail below. FIG. 13 is a flowchart illustrating an aspect of operation 12 of the method of FIG. 2, or operation 56 of FIG. 5, according to the invention, including operation 280 of interpreting first and second direction information and operations 282 and 284 of recovering reference values and an MC error image.

Referring to FIG. 13, in operation 280, first and second direction information is interpreted. Here, the first direction information indicates whether the coder divides each of MBs of an MC error image into horizontal or vertical blocks. The second direction information indicates a predetermined direction along which locally recovered luminance error values of pixels included in a previous block are analyzed when the coder calculates reference values. The first and second direction information may be coded in operation 10 of coding the digital motion picture, and decoded in operation 50 of FIG. 5. It is understood that the first and second directions are not limited to the specific interpretations discussed above and that the first and second direction designations may be switched.

In operation 282, reference values are recovered using the interpreted second direction information and recovered luminance error values of pixels in a previous block. Unlike locally recovered luminance error values, “the recovered luminance error values” refers to luminance error values that are recovered by the decoder.

For example, the second direction information may be interpreted to infer a predetermined direction along which a previous block has been analyzed when the coder generates reference values, and the reference values are recovered using the inferred predetermined direction and recovered luminance error values.

In operation 284, an MC error image is recovered using the recovered reference values, the interpreted first direction information, and a recovered predicted error image. For example, recovered reference values and a recovered predicted error image are added to recover luminance error values of each of blocks of an MC error image, and the luminance error values recovered in all blocks are then put together in a horizontal or vertical direction, as inferred from the interpreted first direction information, to recover the MC error image.

The structure and operation of an apparatus for processing a digital motion picture according to an aspect of the invention is described in detail below.

FIG. 14 is a block diagram of an apparatus for processing a digital motion picture according to an aspect of the invention. Referring to FIG. 14, the apparatus includes a coder 300 and a decoder 302. The apparatus of FIG. 14 performs the method of FIG. 2. For example, to perform operation 10, the coder 300 receives an MC error image, which is the result of removing temporal redundancy of a digital motion picture, via an input node IN1, divides the MC error image into horizontal or vertical blocks, predicts an MC error of a current block using a previous block neighboring the current block by a unit pixel distance, performs OT on a predicted error image having the predicted MC errors, and outputs the coded result to the decoder 302.

To perform operation 12, the decoder 302 recovers the predicted error image by performing IOT, recovers the MC error image from the recovered predicted error image, and outputs the recovered digital motion picture via an output node OUT1.

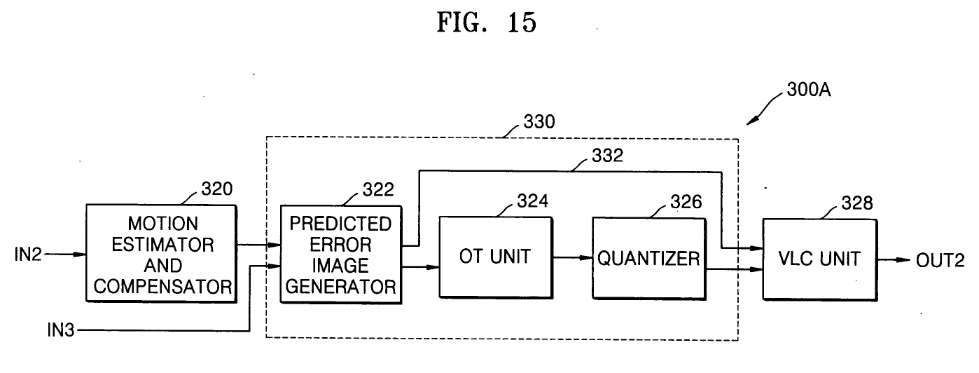

FIG. 15 is a block diagram of an aspect 300A of the coder 300 of FIG. 14, including a motion estimator and compensator 320, a predicted error image generator 322, an OT unit 324, a quantizer 326, and a VLC unit 328.

The coder 300A of FIG. 15 performs operation 10A shown in FIG. 4.

To perform operation 30, the motion estimator and compensator 320 removes temporal redundancy of a digital motion picture, which is input via an input node IN2, and outputs the result as an MC error image to the predicted error image generator 322.

To perform operation 32, the predicted error image generator 322 receives the MC error image from the motion estimator and compensator 320, divides the MC error image into horizontal or vertical blocks, predicts an MC error of a current block using a previous block neighboring by a unit pixel distance to the current block, and outputs a predicted error image having the predicted MC errors to the OT unit 324. Here, the predicted error image generator 322 may output first and second direction information 332, as previously described, to the VLC unit 328. To output the first and second direction information 332, the predicted error image generator 322 may receive information concerning a predetermined direction and a predetermined number of groups into which a current block is to be segmented via an input node IN3.

To perform operation 34, the OT unit 324 performs an OT on the predicted error image input from the predicted error image generator 322 and outputs the result of the OT to the quantizer 326.

To perform operation 36, the quantizer 326 quantizes the result of the OT and outputs the quantization results to the VLC unit 328.

Here, the predicted error image generator 322, the OT unit 324, and the quantizer 326 serve to remove spatial redundancy from the result of removing temporal redundancy of the digital motion picture.

To perform operation 38, the VLC unit 328 performs VLC on the quantization results and outputs the result of VLC to the decoder 302 via an output node OUT2. Here, the result of VLC output via the output node OUT2 may not be transmitted to the decoder 302 but instead stored in an additional storage, as described above.

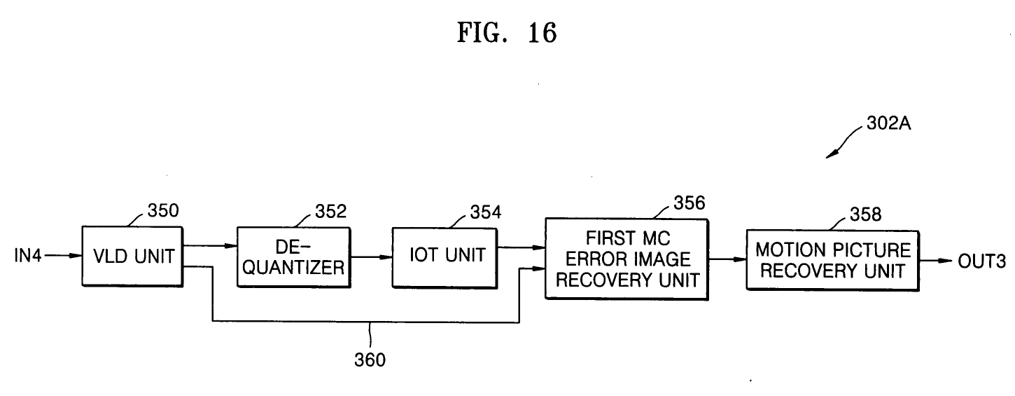

FIG. 16 is a block diagram of an aspect 302A of the decoder 302 of FIG. 14, including a VLD unit 350, an inverse quantizer 352, an IOT unit 354, a first MC error image recovery unit 356, and a motion picture recovery unit 358. The decoder 302A performs operation 12A of FIG. 5.

To perform operation 50, the VLD unit 350 receives the result of VLC via an input node IN4 and performs VLD on the result of VLC. The VLD unit 350 outputs a result 360, obtained by decoding first and second direction information of the results of VLD, to the first MC error image recovery unit 356.

To perform operation 52, the inverse quantizer 352 inverse-quantizes the results of VLD input from the VLD unit 350 and outputs the inverse quantization results to the IOT unit 354.

To perform operation 54, the IOT unit 354 performs IOT on the inverse quantization results input from the inverse quantizer 352 and outputs the result of IOT as a recovered predicted error image to the first MC error image recovery unit 356.

To perform operation 56, the first MC error image recovery unit 356 recovers an MC error image from the recovered predicted error image input from the IOT unit 354 and outputs the recovered MC error image to the motion picture recovery unit 358.

To perform operation 58, the motion picture recovery unit 358 recovers a digital motion picture from the recovered MC error image input from the first MC error image recovery unit 356 and outputs the recovery result via an output node OUT3.

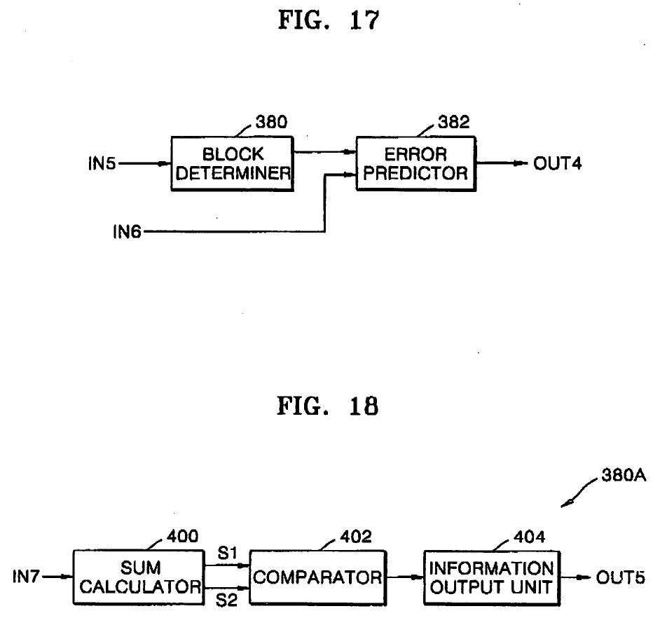

FIG. 17 is a block diagram of the coder 300 of FIG. 14, or the predicted error image generator 322 of FIG. 15, according to an aspect of the invention, including a block determiner 380 and an error predictor 382. The block determiner 380 and the error predictor 382 of FIG. 17 perform operations 70 and 72 of FIG. 6, respectively. To perform operation 70, the block determiner 380 determines whether each of MBs of an MC error image input via an input node IN5 is divided into horizontal or vertical blocks and outputs the determination result to the error predictor 382. To perform operation 72, the error predictor 382 predicts an MC error of a current block using a previous block neighboring the current block by a predetermined pixel distance in response to the determination result of the block determiner 380, and outputs a predicted error image having predicted MC errors of blocks via an output node OUT4. The predetermined pixel distance may be a distance of one unit pixel.

FIG. 18 is a block diagram of an aspect 380A of the block determiner 380 of FIG. 17, including a sum calculator 400, a comparator 402, and an information output unit 404. The block determiner 380A executes operation 70A of FIG. 8.

The sum calculator 400 performs operation 140. For example, the sum calculator 400 sums absolute values of differences between luminance error values of horizontally neighboring pixels in an MB input via an input node IN7 to calculate a first sum S1, as shown above in Equation 1. The sum calculator 400 sums absolute values of differences between luminance error values of vertically neighboring pixels in the MB input via the input node IN7 to calculate a second sum S2, as shown above in Equation 2.

To perform operations 142 and 144, the comparator 402 compares the first and second sums S1 and S2 input from the sum calculator 400 and outputs the comparison result to the information output unit 404.

To perform operations 146, 148, and 150, the information output unit 404 determines whether the MB is divided into horizontal or vertical blocks in response to the comparison result of the comparator 402 and outputs information indicating the determination result to the error predictor 382 via an output node OUT5.

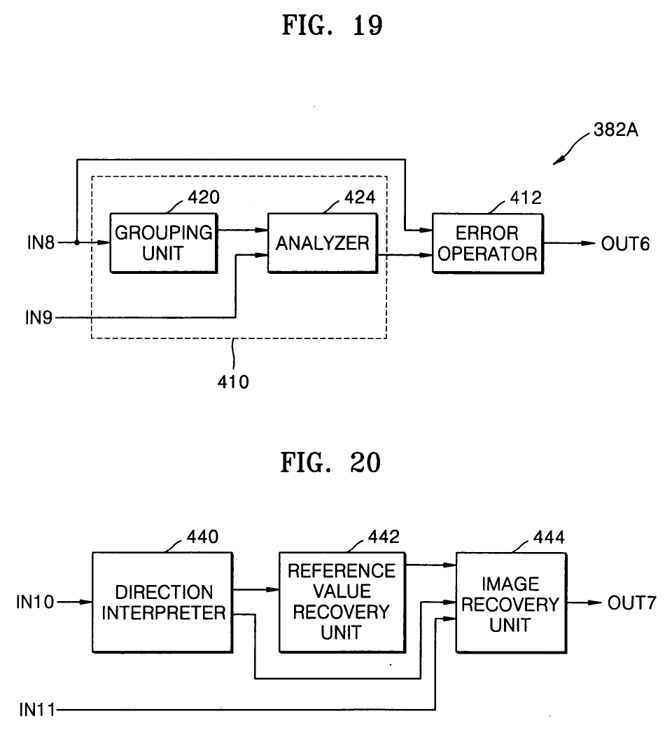

FIG. 19 is a block diagram of an aspect 382A of the error predictor 382 of FIG. 17 according to of the invention, including a reference value generator 410 and an error operator 412. The error-predictor 382A of FIG. 19 performs operation 72A of FIG. 10.

According to an aspect of the invention, when operation 72 includes operations 172 and 174 of FIG. 10, as describe above, the reference value generator 410 may include only an analyzer 424.

According to another aspect of the invention, when operation 72 includes operations 170, 172, and 174 of FIG. 10, the reference value generator 410 may include a grouping unit 420 and the analyzer 424.

To carry out operations 170 and 172, the reference value generator 410 generates a reference value of each of pixels in a current block input via an input node IN8 from locally recovered luminance error values of pixels in a previous block input via an input node IN9, and outputs the generated reference value to the error operator 412. For example, to perform operation 170, the grouping unit 420 classifies the pixels in the current block input via the input node IN8 into a predetermined number of groups as shown in FIGS. 11B through 11E, and outputs information on the resulting groups to the analyzer 422.

When the reference value generator 410 includes only the analyzer 424, to perform operation 172, the analyzer 424 analyzes the locally recovered luminance error values of the pixels in the previous block input via the input node IN9 in a predetermined direction to generate the reference value, and outputs the generated reference value to the error operator 412.

When reference value generator 410 includes the grouping unit 420 and the analyzer 424 to carry out operation 172, the analyzer 424 analyzes the locally recovered luminance error values of the pixels in the previous block input via the input node IN9 in a predetermined direction, equally applied to each group of pixels, to generate the reference value, and outputs the generated reference value to the error operator 412. For example, the analyzer 424 determines from the resulting groups input from the grouping unit 420 whether pixels whose reference values are to be calculated belong to the same group, and calculates reference values of pixels belonging to the same group in the same predetermined direction as previously described.

To perform operation 174, the error operator 412 subtracts the reference value input from the analyzer 424 from a luminance error value of each of the pixels in the current block input via the input node IN8, determines the subtraction result as a predicted MC error of each of pixels of each block, and outputs the predicted MC error via an output node OUT6.

FIG. 20 is a block diagram of the decoder 302 of FIG. 14, or the first MC error image recovery unit 356 of FIG. 16, according to an aspect of the invention, including a direction interpreter 440, a reference value recovery unit 442, and an image recovery unit 444. The direction interpreter 440, the reference value recovery unit 442, and the image recovery unit 444 of FIG. 20 perform operations 280, 282, and 284 of FIG. 13, respectively.

To perform operation 280, the direction interpreter 440 interprets first and second direction information input via an input node IN10, outputs the interpreted first direction information to the image recovery unit 444, and outputs the interpreted second direction information to the reference value recovery unit 442. Here, when the block diagram of FIG. 20 corresponds to the first MC error image recovery unit 356 of FIG. 16, the first and second direction information, which is input to the direction interpreter 440 via the input node IN10, may be output from the VLD unit 350 of FIG. 16.

To perform operation 282, the reference value recovery unit 442 recovers reference values from the second direction information interpreted by the direction interpreter 440 and recovered luminance error values of pixels in a previous block, and outputs the recovered reference values to the image recovery unit 444.

To perform operation 284, the image recovery unit 444 recovers an MC error image from the recovered reference values input from the reference value recovery unit 442, the interpreted first direction information input from the direction interpreter 440, and a recovered predicted error image input via an input node IN11, and outputs the recovery result via an output node OUT7. Here, when the block diagram of FIG. 20 corresponds to an aspect of the first MC error image recovery unit 356 of FIG. 16, the recovered predicted error image, which is input to the image recovery unit 444 via the input node IN11, may be output from the IOT unit 354 of FIG. 16.

Hereinafter, the method and apparatus for processing a digital motion picture according to an aspect of the invention will be compared with a conventional method and apparatus for processing a digital motion picture, in terms of power. Power refers to the result of summing squares of predicted MC errors of P×Q pixels when an MC error image has a size of P×Q (width×length).

Table 1 lists power comparison data obtained by processing five digital motion pictures using the digital motion picture processing method and apparatus according to an aspect of the invention and a conventional digital motion picture processing method and apparatus, when a predetermined number of groups of pixels was “1”, a predetermined direction was determined as in Equation 3 or 4 above, a quantization magnitude was “5”, and M=N=16.

TABLE 1

| Digital Motion | | |
|---|---|---|
| Picture No. | Conventional Art | Present Invention |
| 1 | 7249151 | 4635764 |
| 2 | 778857 | 642534 |
| 3 | 2723095 | 1854314 |
| 4 | 2274103 | 1824485 |
| 5 | 16290092 | 8592750 |

As shown in Table 1, the digital motion picture processing method and apparatus according to an aspect of the invention consumes less power than the conventional digital motion picture processing method and apparatus. This reduction in power indicates that an amount of data to be coded is reduced and thus coding efficiency is considerably improved by the invention.

Table 2 lists power comparison data for the digital motion picture processing method and apparatus according to an aspect of the invention and the conventional digital motion picture processing method and apparatus when the quantization magnitude is changed from “5” to “15”, using the assumption discussed above.

TABLE 2

| Digital Motion | | |
|---|---|---|
| Picture No. | Conventional Art | Present Invention |
| 1 | 7249151 | 6683817 |
| 2 | 778857 | 770559 |
| 3 | 2723095 | 2473157 |
| 4 | 2274103 | 2188026 |
| 5 | 16290092 | 11899225 |

As can be seen in Table 2, even when the quantization magnitude is changed to “15”, the digital motion picture processing method and apparatus according to an aspect of the invention consumes less power than the conventional digital motion picture processing method and apparatus. Therefore, the digital motion picture processing method and apparatus of the invention consumes less power than the conventional digital motion picture processing method and apparatus regardless of the quantization magnitude.

As described above, a method and apparatus for processing a digital motion picture according to the invention may be easily applied to a method and apparatus for processing a conventional motion picture. Further, since an MC error may be efficiently predicted from an MC error image, impulse components of an MC error to be coded may be alleviated to reduce the MC error itself. As a result, data compression efficiency of OT can be improved and correlation among pixels can be lowered. Moreover, even when an MB includes a plurality of different motion components, error around the edge of the MC error image can be relatively reduced, in comparison to the conventional art.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of processing a digital motion picture, comprising:
when the digital motion picture is coded, dividing a motion compensation error image into horizontal or vertical blocks, predicting a motion compensation error of a current block using a previous block neighboring the current block by a predetermined pixel distance, and performing an orthogonal transform on a predicted error image that includes the predicted motion compensation errors; and
when the coded digital motion picture is decoded, recovering the predicted error image by performing an inverse orthogonal transform on the predicted error message and recovering the motion compensation error image from the recovered predicted error image,
wherein the current block is a block to be currently processed and the previous block is a block previously processed, and
wherein the motion compensation error image is the result of removing temporal redundancy of the digital motion picture.

2. The method of processing the digital motion picture of claim 1, wherein when the digital motion picture is coded, the method further comprises:
quantizing the result of the orthogonal transform; and
performing variable length coding on the quantization results.

3. The method of processing the digital motion picture of claim 2, wherein when the digital motion picture is decoded, the method further comprises:
performing variable length decoding on the variable length coding result;
inverse-quantizing the variable length decoding result;
recovering the predicted error image by performing the inverse orthogonal transform on the inverse quantization results;
recovering the motion compensation error image from the recovered predicted error image; and
recovering the digital motion picture using the recovered motion compensation error image.

4. The method of processing the digital motion picture of claim 1, wherein obtaining the predicted error image from the motion compensation error image comprises:
determining whether each of macroblocks in the motion compensation error image is divided into horizontal or vertical blocks; and
obtaining the predicted error image by predicting the motion compensation error of the current block using the previous block neighboring the current block by the predetermined pixel distance.

5. The method of processing the digital motion picture of claim 4, wherein the determining whether each of the macroblocks in the motion compensation error image is divided into the horizontal or vertical blocks comprises:
summing absolute values of differences between luminance error values of horizontally neighboring pixels to calculate a first sum S1 and summing absolute values of differences between luminance error values of vertically neighboring pixels to calculate a second sum S2, using the equations below:
$$\begin{matrix}S 1 = {\sum }_{i = 1}^{M} {\sum }_{j = 1}^{N - 1} \vert {Z}_{ij} - {Z}_{i ( j + 1 )} \vert \\ S 2 = {\sum }_{l = 1}^{N} {\sum }_{k = 1}^{M - 1} \vert {Z}_{kl} - {Z}_{( k + 1 ) l} \vert\end{matrix}$$
wherein variables M and N denote length and width of each of the macroblocks, respectively, and variable Z denotes the luminance error values;
determining whether the first sum S1 is greater than the second sum S2;
dividing each of the macroblocks into the horizontal blocks when the first sum S1 is determined to be greater than the second sum S2; and
dividing each of the macroblocks into the vertical blocks when the first sum S1 is determined to be less than the second sum S2.

6. The method of processing the digital motion picture of claim 5, wherein the determination of whether each of the macroblocks in the motion compensation error image is divided into the horizontal or vertical blocks further comprises:
dividing each of the macroblocks into predetermined horizontal or vertical blocks when the first sum S1 is equal to the second sum S2.

7. The method of processing the digital motion picture of claim 4, wherein the predicting the motion compensation error of the current block using the previous block comprises:
calculating a reference value of each of pixels in the current block using locally recovered luminance error values of pixels in the previous block; and
subtracting the reference value from a luminance error value of each of the pixels in the current block and determining the subtracted result as the predicted motion compensation error.

8. The method of processing the digital motion picture of claim 7, wherein the calculating the reference value of each of the pixels in the current block comprises:
classifying the pixels in the current block into at least one group of a predetermined number of groups; and
analyzing the locally recovered luminance error values of the pixels in the previous block in a predetermined direction, which is equally applied to each of the at least one group, to calculate the reference value.

9. The method of processing the digital motion picture of claim 8, further comprising:
calculating a reference value r(x) of a pixel at a random position x of the current block using one of the following equations:
$$r ( x ) = 0 , \\ r ( x ) = p ( x ) , \\ r ( x ) = p ( x - 1 ) , \\ r ( x ) = p ( x + 1 ) , \\ r ( x ) = \frac{p ( x - 1 ) + P ( x ) + 1}{2} , \\ or$$
$$r ( x ) = \frac{p ( x ) + p ( x + 1 ) + 1}{2}$$
wherein p(x) denotes the locally recovered luminance error value of the pixel at the position x of the previous block.

10. The method of processing the digital motion picture of claim 8, wherein the digital motion picture is decoded, the method further comprises:
interpreting first and second direction information;
recovering the reference values using the interpreted second direction information and recovered luminance error values of the pixels in the previous block; and
recovering the motion compensation error image using the recovered reference values, the interpreted first direction information, and the predicted error image,
wherein the first direction information indicates whether each of the macroblocks in the motion compensation error image is divided into horizontal or vertical blocks, and the second direction information indicates the predetermined direction.

11. The method of processing the digital motion picture of claim 1, wherein the predetermined pixel distance is a distance of one pixel unit.

12. An apparatus for processing a digital motion picture, comprising:
a coder that divides a motion compensation error image, which results from removing a temporal redundancy of the digital motion picture, into horizontal or vertical blocks, predicts a motion compensation error of a current block using a previous block neighboring the current block by a predetermined pixel distance, and performs an orthogonal transform on a predicted error image having the predicted motion compensation errors; and
a decoder that recovers the predicted error image by performing an inverse orthogonal transform and recovers the motion compensation error image from the recovered predicted error image,
wherein the current block is a block to be currently processed, and the previous block is a block previously processed.

13. The apparatus for processing the digital motion picture of claim 12, wherein the coder comprises:
a motion estimator and compensator unit that removes the temporal redundancy of the digital motion picture and outputs the result as the motion compensation error image;
a predicted error image generator that receives the motion compensation error image, divides the motion compensation error image into the horizontal or vertical blocks, predicts the motion compensation error of the current block using the previous block neighboring by the predetermined pixel distance to the current block, and outputs the predicted error image having the predicted motion compensation errors;
an orthogonal transform unit that performs the orthogonal transform on the predicted error image;
a quantization unit that quantizes the result of the orthogonal transform; and
a variable length coding unit that performs variable length coding on the quantization results and outputs the result of variable length coding.

14. The apparatus for processing the digital motion picture of claim 12, wherein the decoder comprises:
a variable length decoding unit that performs variable length decoding on the variable length coding result;
an inverse quantization unit that inverse-quantizes the variable length decoding result;
an inverse orthogonal transform unit that performs the inverse orthogonal transform on the inverse quantization results and outputs the result of the inverse orthogonal transform as the recovered predicted error image;
a first motion compensation error image recovery unit that recovers the motion compensation error image from the recovered predicted error image; and
a motion picture recovery unit that recovers the digital motion picture from the recovered motion compensation error image.

15. The apparatus for processing the digital motion picture of claim 12, wherein the coder comprises:
a block determiner that determines whether each of macroblocks in the motion compensation error image is divided into horizontal or vertical blocks and outputs the determination result; and
an error predictor that predicts the motion compensation error of the current block from the previous block neighboring the current block by the predetermined pixel distance in response to the determination result, and outputs predicted motion compensation errors of blocks as the predicted error image.

16. The apparatus for processing the digital motion picture of claim 15, wherein the block determiner comprises:
a sum calculator that sums absolute values of differences among luminance error values of horizontally neighboring pixels in each of the macroblocks to calculate a first sum S1, and sums absolute values of differences among luminance error values of vertically neighboring pixels in each of the macroblocks to calculate a second sum S2, using the following equations;
$$\begin{matrix}S 1 = {\sum }_{i = 1}^{M} {\sum }_{j = 1}^{N - 1} \vert {Z}_{ij} - {Z}_{i ( j + 1 )} \vert \\ S 2 = {\sum }_{l = 1}^{N} {\sum }_{k = 1}^{M - 1} \vert {Z}_{kl} - {Z}_{( k + 1 ) l} \vert\end{matrix}$$
wherein variables M and N denote length and width of each of the macroblocks, respectively, and Z denotes the luminance error values,
a comparator that compares the first and second sums S1 and S2 and outputs the comparison result; and
an information output unit that determines whether each of the macroblocks is divided into the horizontal or vertical blocks in response to the comparison result, and outputs information indicating the determination result.

17. The apparatus for processing the digital motion picture of claim 15, wherein the error predictor comprises:
a reference value generator that generates a reference value of each of pixels in the current block from locally recovered luminance error values of pixels in the previous block; and
an error operator that subtracts the reference value from a luminance error value of each of the pixels in the current block and determines the subtracted result as the predicted motion compensation error.

18. The apparatus for processing the digital motion picture of claim 17, wherein the reference value generator comprises:
a grouping unit that classifies the pixels in the current block into at least one group of a predetermined number of groups; and
an analyzer that analyzes the locally recovered luminance error values of the pixels in the previous block in a predetermined direction, which is equally applied to each of the at least one group, to generate the reference value.

19. The apparatus for processing the digital motion picture of claim 18, wherein the decoder comprises:
a direction interpreter that interprets first and second direction information;
a reference value recovery unit that recovers the reference values from the interpreted second direction information and recovered luminance error values of the pixels in the previous block; and
a second motion compensation error image recovery unit that recovers the motion compensation error image from the recovered reference values, the interpreted first direction information, and the recovered predicted error image,
wherein the first direction information indicates whether each of the macroblocks in the motion compensation error image is divided into horizontal or vertical blocks, and the second direction information indicates the predetermined direction.

20. The apparatus of processing the digital motion picture of claim 12, wherein the predetermined pixel distance is a distance of one pixel unit.

21. A method of coding a digital moving image, comprising:
coding the moving image by dividing a coded motion compensation error image into directional blocks;
predicting a motion compensation error of a currently processed block using a previously processed block located a predetermined pixel distance from the block; and
performing an orthogonal transform on a predicted error image that includes the predicted motion compensation errors.

22. The method of processing the digital moving image of claim 21, further comprising:
transmitting the coded moving image to a decoder to be read and/or decoded.

23. The method of processing the digital moving image of claim 21, further comprising:
storing the coded moving image to be transmitted to a decoder to be read and/or decoded at a later time.

24. The method of processing the coded digital moving image of claim 21, wherein a temporal redundancy is removed from the coded motion compensation error image prior to dividing the motion compensation error into directional blocks.

25. The method of processing the coded digital moving image of claim 21, wherein the motion compensation error images are divided into horizontal or vertical blocks.

26. The method of processing the coded digital moving image of claim 21, wherein the predetermined pixel distance is a distance of one pixel unit.

27. A method of processing a coded digital moving image, comprising:
receiving a coded moving image;
recovering a predicted error image by performing an inverse orthogonal transform on a predicted error message and recovering the motion compensation error image from the recovered predicted error image; and
processing a block of the moving image according to the resulting motion compensation error image.

28. The method of processing the coded digital moving image of claim 27, further comprising:
performing variable length decoding on the coded moving image;
inverse-quantizing the variable length decoding result;
recovering the predicted error image by performing an inverse orthogonal transform on the inverse quantizing result;
recovering the motion compensation error image from the recovered predicted error image; and
recovering the digital moving image using the recovered motion compensation error image.
